(19) United States
(12) Patent Application Publication
(10) Pub. No.: US 2009/0279004 A1
(43) Pub. Date: Nov. 12, 2009

(54) GLAZING

(75) Inventors: Michael Robert Greenall, Lancashire (GB); Ashley Carl Torr, Lancashire (GB); Jonathan Peter Voss, Lancashire (GB)

Correspondence Address: BUCHANAN, INGERSOLL & ROONEY PC, POST OFFICE BOX 1404, ALEXANDRIA, VA, 22313-1404, US

(73) Assignees: PILKINGTON GROUP LIMITED, St Helens, Merseyside (GB); PILKINGTON AUTOMOTIVE LIMITED, St Helens, Merseyside (GB)

(21) Appl. No.: 12/297,167

(22) PCT Filed: Apr. 20, 2007
(86) PCT No.: PCT/GB07/50205

§ 371 Date: Nov. 20, 2008

(30) Foreign Application Priority Data
Apr. 20, 2006 (GB) 0607746.5

(51) Int. Cl. G02F 1/1335

(52) U.S. Cl. 349/16; 349/193

(57) ABSTRACT

A laminated glazing comprises two plies of glass having an interlayer structure laminated therebetween. The interlayer structure comprises a first sheet of an interlayer material framing a liquid crystal film incorporated therein. Preferably, the interlayer material does not contain plasticizers, or contains a plasticizer which does not diffuse into the liquid crystal film structure. In addition, the interlayer material preferably resists the migration of mobile liquid crystal film components.

The present invention relates to a method of manufacturing a laminated glazing, in particular, a method of manufacturing a glazing containing a functional film.

In recent years, glazings having some form of additional functionality have become increasingly popular and sought-after. Typically, additional functionality is provided by using at least one ply of coated or tinted glass within a laminated glazing structure, to provide heat or UV-reflective properties. However, additional functionality can also be provided by including a functional device or film within a laminated glazing structure. Such devices or films may include lighting devices, such as LEDs (light emitting diodes), or switchable films, such as SPDs (suspended particle devices) or LCDs (liquid crystals).

One particular use of LCD films is in rooflights, where it may be desirable to provide a method of controlling the amount of light entering the glazing. For example, in WO02/072408, an LCD film may be used in a laminated glazing roof structure in a transparent or non-transparent state. In the non-transparent state, the LCD film reduces transmission of light through the roof into the vehicle, and may prevent the fragmentation of the glass in the roof, if broken. The LCD is formed from a liquid crystal film adhered to the lower side of the inner ply of glass. An additional ply of glass is then provided to protect the liquid crystal film.

However, rather than providing an additional ply of glass to protect the LCD film, which adds weight and cost to a roof glazing, it is preferable to include the LCD film within the laminated glazing structure, as the whole, or part of, the interlayer. The interlayer used in such constructions is typically a PVB (poly vinyl butyral) interlayer. In order to protect the LCD film within the interlayer, it is preferable that the edges of the film do not reach the edges of the glass. It is known to use a “picture frame” design, where three layers of interlayer material, rather than the usual one, are used to laminate the LCD film within a glazing. A central layer, approximately the same thickness as the LCD film, is cut such that the film can be placed within an interlayer frame. The film and interlayer frame are then placed between two further interlayers, and laminated between two plies of glass.

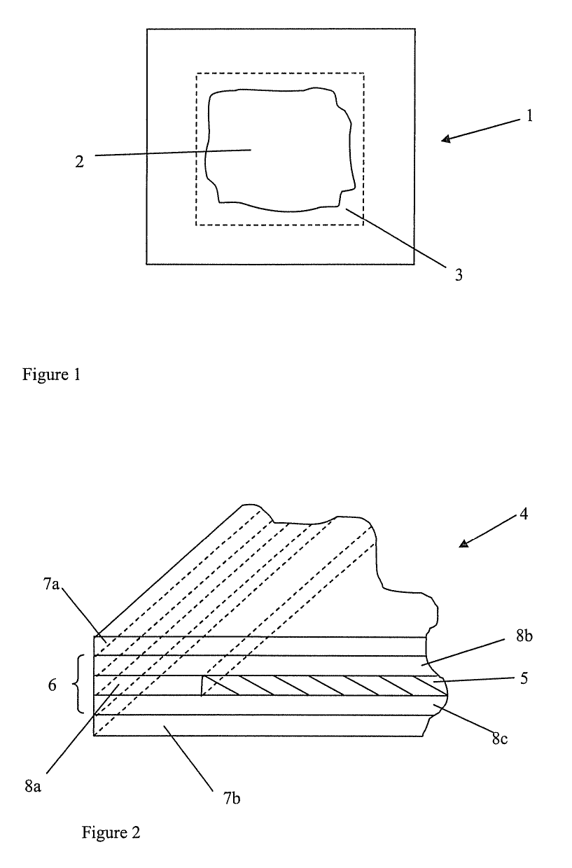

As part of the laminating process, the LCD film, interlayers and plies of glass may be autoclaved, and subjected to pressure at elevated temperature. However, when PVB interlayers are used, the edge region of the LCD film becomes damaged during the autoclaving process. FIG. 1 shows a schematic plan view of a glazing 1 having an LCD film 2 laminated therein. A clear border region 3, which is entirely even in width has appeared around the edge of the LCD film 2. The size of the clear region increases with autoclaving temperature and duration, and is non-reversible. The dotted line in FIG. 1 illustrates the “picture frame” construction, and illustrates the position of the actual edge of the LCD film 2.

Clearly, the presence of a border region within the LCD film is unacceptable from a quality control point of view, as it affects the visual appearance of the glazing. There is therefore a need for a laminated glazing which enables an LCD film to be included within a laminated glazing, which minimises or prevents degradation of the film occurring at any point during the manufacture of the glazing.

The present invention aims to address these problems by providing a laminated glazing comprising first and second plies of glass having an interlayer structure laminated therebetween, the interlayer structure comprising a first sheet of an interlayer material framing a liquid crystal film incorporated therein, wherein the components of the interlayer material do not comprise a plasticizer or comprise a plasticizer that does not migrate into the liquid crystal film.

Preferably, the interlayer material also resists the migration of mobile liquid crystal film components into the interlayer material.

The present invention also provides a laminated glazing comprising first and second plies of glass having an interlayer structure laminated therebetween, the interlayer structure comprising a first sheet of an interlayer material framing a liquid crystal film incorporated therein, wherein the interlayer material resists the migration of mobile liquid crystal film components into the interlayer material.

Preferably, the interlayer material components do not comprise a plasticizer or comprise a plasticizer that does not migrate into the liquid crystal film.

It has been appreciated that migration and solution behaviour of the plasticizer and other mobile interlayer components from interlayer materials such as PVB in to LCD films, and LCD film components into the PVB interlayer is at least partly responsible for the clear border region observed in laminated glazings containing LCD films. By providing a structure where the LCD film is in contact with a material containing little or no plasticizer, or a plasticizer which does not migrate into the LCD film the observed damage can be reduced or even eliminated.

Preferably, the first sheet of interlayer material is laminated between a second and a third sheet of an interlayer material, each in contact with and co-extensive with one of the first and second plies of glass, the liquid crystal film being in contact with at least one sheet of interlayer material.

Preferably, the interlayer material components comprise a plasticizer that does not migrate into the liquid crystal film. More preferably, the mobile interlayer material components do not comprise a plasticizer.

At least one of the first, second and third sheets of interlayer material may be one of ethylene vinyl acetate copolymer, polyurethane, polycarbonate, poly vinyl chloride or a copolymer of ethylene and methacrylic acid.

The laminated structure may comprise a fourth sheet of interlayer material and a barrier layer, the barrier layer being between the first and third sheets of interlayer material, or the third and fourth sheets of interlayer material. The barrier layer is preferably poly ethylene terephthalate. The fourth sheet of interlayer material is preferably poly vinyl butyral. The fourth sheet of interlayer material may be coloured and/or have acoustic properties.

Alternatively, the liquid crystal film may comprise a coloured substrate.

Alternatively, the laminated glazing may further comprise a poly ethylene terephthalate substrate having a heat reflective solar control coating and a fifth sheet of an interlayer material, interposed between the fourth sheet of interlayer material and the second ply of glass.

At least one sheet of interlayer material may have solar control properties.

Preferably, the laminated glazing further comprises at least one of a solar control, heat reflective, low-emissivity, hydrophobic or hydrophilic coating.

The laminated glazing may comprise a third ply of glass, separated from the second ply of glass by an air gap.

Preferably, the thickness of the first sheet of interlayer material is of the same order as the thickness of the liquid crystal film.

The present invention will now be described by way of example only, and with reference to the accompanying drawings in which:

FIG. 1, as referred to above, is a schematic plan view of a laminated glazing having an LCD film laminated therein;

FIG. 2 is a schematic cross-section showing the construction of a laminated glazing having an LCD film laminated therein;

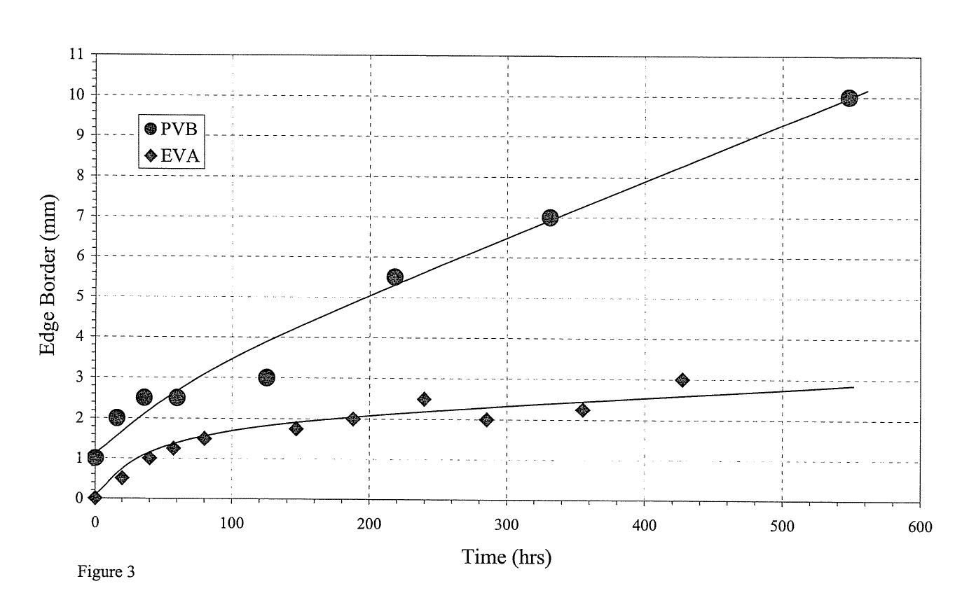

FIG. 3 is a chart showing the progression of the border region with time;

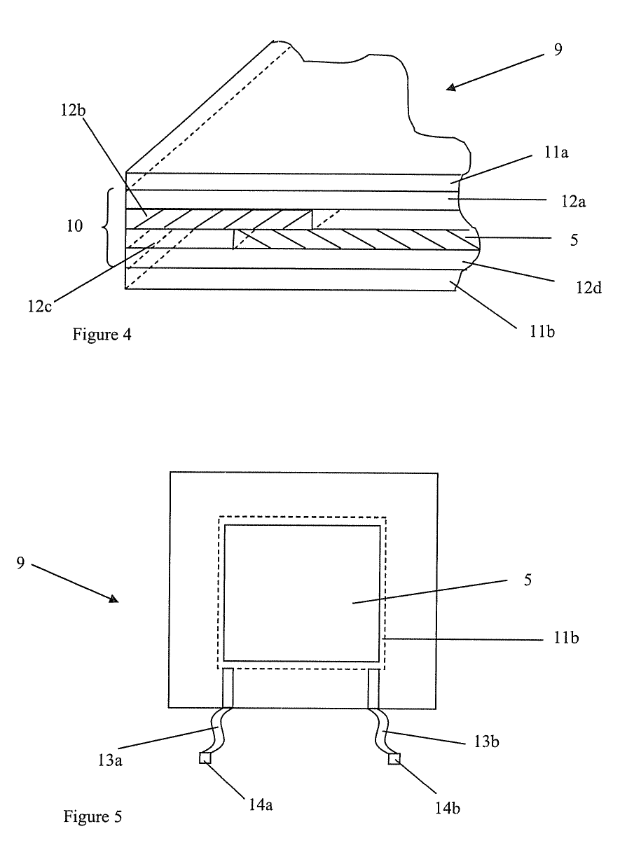

FIG. 4 is a schematic cross-section showing the construction of a laminated glazing having an LCD film laminated therein, showing a second picture frame design;

FIG. 5 is a schematic plan view of a laminated glazing having an LCD film laminated therein, showing a second picture frame design;

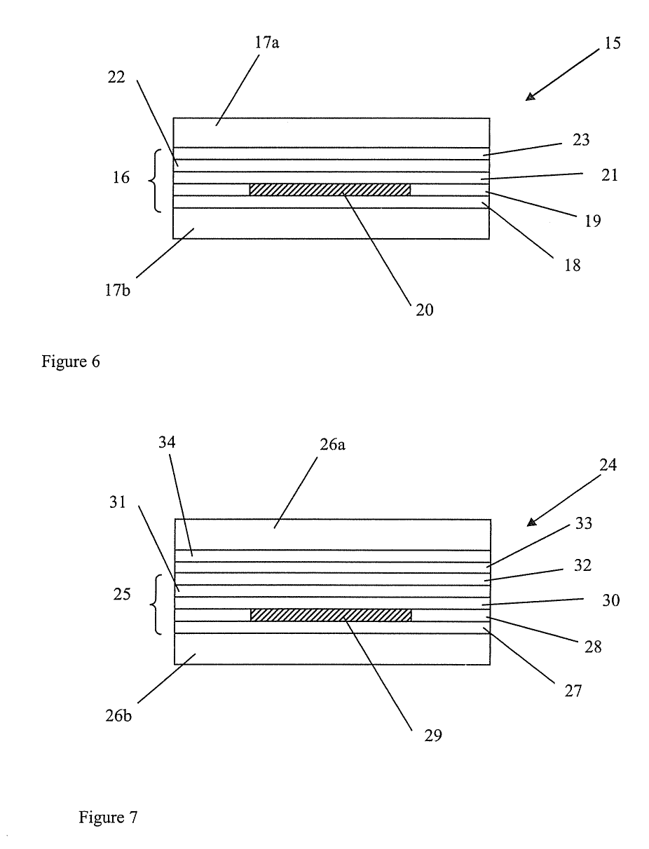

FIG. 6 is a schematic cross section view of a further laminated glazing in accordance with the present invention;

FIG. 7 is a schematic cross section view of a further laminated glazing in accordance with the present invention; and

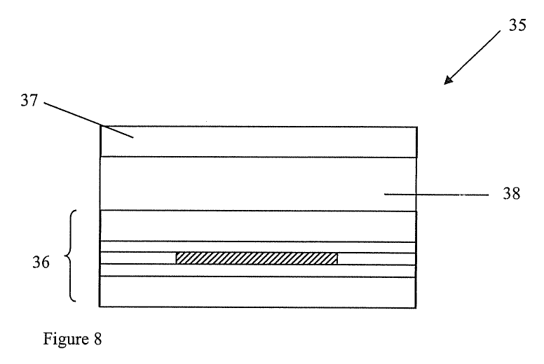

FIG. 8 is a schematic cross section view of a double-glazed structure including an LCD film in accordance with the present invention.

It has been appreciated that there are two mechanisms influencing the formation of the clear edge region within the liquid crystal (LCD) film in a laminated glazing. By determining these mechanisms, it has been possible to develop a laminated glazing where the presence of the clear border region within the LCD film is minimised. PVB interlayer materials generally contain a large amount of plasticizer, which determines the rigidity and flexibility of the interlayer, as well as influencing the mechanical strength and adhesion properties. Both of the mechanisms described below are affected by the behaviour of the plasticizer within the PVB interlayer.

A first mechanism by which the clear region may be formed is migration of the liquid crystal molecules out of the LCD film and into the surrounding interlayer regions. If the liquid crystal molecules are mobile at elevated temperatures, they can diffuse out of the film into the polymer matrix of the interlayer material. Such an effect is noticeable when the permeability of the of the liquid crystal molecules in the interlayer polymer material is high enough. The presence of certain types of plasticizer within the interlayer may help to solvate the liquid crystal molecules, increasing the rate of diffusion out of the liquid crystal film. Other interlayer material components, such as additives for UV (ultra-violet light) resistance, may also migrate into the LCD film.

A second mechanism by which the clear region may be formed is by migration of the plasticizer from within the PVB interlayer into the LCD film. If the plasticizer penetrates the edge of the film, it diffuses into the LCD matrix. Once diffusion into the LCD matrix occurs, the rate of diffusion of the liquid crystal molecules out of the LCD film, and into the polymer matrix of the PVB interlayer, may increase.

The presence of plasticizer within the interlayer material is therefore an important factor in the creation of the clear border region within the LCD film. By the use of low plasticizer content or plasticizer free interlayer materials, or the use of plasticizers which do not diffuse into the film, the clear border region may be reduced in size or even eliminated, depending on the effect of other interlayer components. Suitable interlayer materials include, but are not limited to, EVA (a copolymer of ethylene vinyl acetate), PVC (poly vinyl chloride) PU (polyurethane), PC (polycarbonate) and copolymers of ethylene/methacrylic acid. If an interlayer containing little plasticizer is used, preferably the amount of plasticizer contained therein is less than that of standard automotive PVB.

In order to compare the effects of plasticizer-free interlayer materials with a plasticizer-containing PVB interlayer, two sets of samples were made, one set with a PVB interlayer structure and one set with an EVA interlayer structure. The PVB interlayer used was a RZN-12 interlayer, available from Sekisui Chemical Co. Ltd, and the EVA interlayer used was an EN interlayer, also available from Sekisui Chemical Co. Ltd. FIG. 2 is a schematic cross-section showing the construction of a glazing having an LCD film laminated therein. The glazing 2 has an LCD film 2 laminated within an interlayer structure 6, which is itself laminated between two plies of glass 7a, 7b. The laminated structure 6 comprises three layers of interlayer material 8a, 8b, 8c. The first interlayer 8a has a region cut of the centre in which the LCD film sits, such that the first interlayer 8a forms the “picture frame”. Preferably the thickness of the LCD film 2 is of the same order as the third interlayer 8a. The first interlayer 8a is laminated between second and third interlayers 8a, 8b, which are co-extensive with the plies of glass 7a, 7b.

Samples were prepared in the following manner. Firstly, the connectors were prepared. The LCD films used in the samples were polymer dispersed LCD films. Suitable LCD films are available under the trade mark UMU from NSG Group, Sumitomo Fudosan Mta Twin Building, West Wing, 5-27, Mita 3-Chome, Minato-ku, Tokyo, 108-6321 Japan. Each film comes with two pre-applied busbar connectors on one edge. Electrical connectors were joined to the pre-applied busbars by soldering to enable power to be supplied to the film.

Secondly, once the soldering was completed, the samples were laid up for lamination. Three sheets of interlayer material (0.76 mm, 0.38 mm and 0.76 mm thick respectively for the PVB interlayer, and 0.40 mm, 0.40 mm and 0.40 mm respectively for the EVA interlayer) were placed between the two plies of glass to be used to form the sample, and trimmed to the external size of the plies of glass. The LCD film was then used as a template to mark a hole in the sheet of 0.38 mm/0.40 mm thick interlayer material, and a hole cut approximately 1-2 mm oversize of the mark, This forms the “picture frame” in which the LCD film is placed. The sheets of interlayer material and LCD film were then laid up on the glass to create the structure shown in FIG. 2.

Thirdly, the samples were laminated. Each sample was vacuum bagged and placed in an oven at 105° C. for 40 minutes at 1 bar. Once the lamination cycle had been completed, both samples were then heated at elevated temperature at atmospheric pressure for various time periods, in order to determine the extent to which a clear border region appeared under extreme conditions. Once this heating was complete, the samples were inspected visually. Table 1 below shows the width of the observed clear border regions for each set of samples:

TABLE 1
observed clear border region width

| Time/Temperature Cycle | EVA Border Width | PVB Border Width |
|---|---|---|
| 90° C./700 hours | 1 mm | 6 mm |
| 120° C./400 hours | 1-2 mm | 6-10 mm |

The clear border region in the EVA samples was found to be effectively static, although it appeared early on in the heating cycle, while the PVB border width increased with increasing temperature. The border in the EVA material however appeared to be formed by LCD material diffusing into the EVA material, as opposed to mobile plasticizer components diffusing into the LCD film. However, these results indicate that the mechanisms discussed above, whilst not being the entire reason for the appearance of the clear border region, are likely to be dominant in its formation.

In order to determine how the border region behaved over longer time-scales, further samples comprising PVB and EVA interlayers were made and the border widths measured over 600 hours. Samples comprising PVB interlayers were made as described above, whereas those containing EVA interlayers were made using EVA-SAFE interlayer material, available from Bridgestone Corporation, and autoclaved at 125° C. at 1 bar for 2 hours.

FIG. 3 is a chart showing the progression of the border region with time, for samples kept at 90° C. at ambient humbidity. The PVB samples show a border region immediately after lamination, whereas a small border is only seen in the EVA samples after 10 hours. In both cases, the rate at which the border grows decreases with time, with the size of the EVA border region being effective static after 300 hours. However, the size of the border region in the PVB samples continues to increase, even after 500 hours, and shows little signs of tailing off.

Preferably, therefore, the interlayer material chosen should have components that do not comprise a plasticizer or comprise a plasticizer that does not migrate into the liquid crystal film. Alternatively or additionally, the interlayer material should also resist the migration of mobile liquid crystal film components into the interlayer material

When a glazing in accordance with the present invention is used as an automotive glazing, such as a rooflight, a sidelight or a backlight, it is desirable to be able to control the colour of the glazing. One way in which this may be done is to use at least one ply of glass which is tinted, for example, having an LT (light transmission) when measured using CIE Illuminant A of less than 87% at 2.1 mm. In particular, glasses such as those known as GALAXSEE™ and SUNDYM™, available from Pilkington Group Limited, may be used. Preferably the plies of glass used are annealed or semi-toughened before lamination.

An alternative approach, when at least one ply of clear (having an LT of greater than 88%, measured using CIR Illuminant A) is used, is to include at least one layer of a tinted interlayer material, such as PVB, in the laminated structure in which the LCD film is placed. However, as discussed above, any plasticizer within the PVB may affect the structure and appearance of the LCD film. In order to prevent this, it is desirable to remove any contact between the edge of the LCD film and the PVB interlayer. This may be done in a number of ways, for example, by using coloured EVA interlayers.

Alternatively, colour may be added (by means of a dye, for example) to the PET interlayers which form the substrates of the LCD film 5. The amount of colour used may vary from a low level of tint, to hide any off-white colour of the LCD film 5 when not in use, to heavily tinted to provide some thermal and/or optical control to the glazing.

Alternatively, a coloured PVB interlayer may be included by means of a second “picture frame” construction. FIG. 4 is a schematic cross-section of the structure of a glazing 9 having a second “picture frame” construction. An interlayer structure 10 is laminated between two plies of glass 11a, 11b. The interlayer structure 10 comprises four layers: an upper layer 12a, formed of a coloured PVB, which is co-extensive with the upper glass ply 11a, a second picture frame layer 12b, formed of a plasticizer free, or low plasticizer material, such as PET, a first picture frame layer 12c, containing the LCD film 5, and a lower layer 11d, formed of a plasticizer free, or low plasticizer material, and co-extensive with the lower ply of glass 11b. The second picture frame layer 12b prevents the edge of the LCD film 5 from coming into contact with the coloured PVB interlayer, thus preventing degradation of the LCD film 5. The coloured PVB interlayer 12a may contact the LCD film 5 in a central region, to ensure adhesion within the interlayer structure 10.

FIG. 5 is a schematic plan view of a glazing having a first picture frame layer 12c (represented by a dotted line) containing an LCD film 5, showing the second picture frame layer 12b overlapping the first picture frame layer 12c. Busbars 13a, 13b and electrical connectors 14a, 14b are provided to allow the sample to be connected to a power source.

For a glazing to be included in a vehicle, for example, as a rooflight, the busbars and electrical connectors between the LCD film and the wiring harness of the vehicle may be hidden by an obscuration band. This is a band of fired, black ceramic ink around the edge of the upper ply of glass, which acts to cover the adhesive holding the glazing into a vehicle, and electrical connections. The purpose of the band is two-fold, firstly aesthetic, and secondly, to prevent damage of adhesive or other components from UV exposure. The obscuration band may also hide the edges of the LCD film.

When a coloured EVA interlayer material is used in the glazing construction, or a coloured PET substrate used in the manufacture of the LCD film, a clear PVB interlayer material having acoustic properties may be used. Alternatively, a coloured acoustic PVB interlayer material may be used.

FIG. 6 is a schematic cross section view of a glazing 15 comprising a five-layer interlayer structure 16 laminated between two plies of glass 17a, 17b. Preferably, the upper ply of glass 17a is clear, and is provided with a heat reflective solar control coating on its inner surface. The lower ply of glass 17b may be clear or tinted. The interlayer structure 16 comprises a first interlayer 18, a second interlayer 19, having an LCD film 20 incorporated therein, a third interlayer 21, a PET substrate 22 and a fourth interlayer 23. Preferably, the first 18, second 19 and third 21 interlayers are formed of EVA or other suitable interlayer material, as discussed above. The fourth interlayer is preferably a tinted PVB interlayer. In addition, the PVB interlayer may have acoustic or solar/thermal control properties. By using a five-layered interlayer structure, a barrier is provided between the LCD film 19 and a PVB interlayer, removing any issues due to interlayer component migration.

It may be desirable, as an alternative to using a coated glass to provide solar control, to use an interlayer material which provides a degree of solar control. For example, additives such as pigments or nanoparticle systems including LaB₆ or ITO (indium tin oxide), are known for use with PVB interlayers, and may be used in an EVA interlayer in the laminated glazing structure of the present invention.

However, rather than using a solar control interlayer or providing a coating on one of the plies of glass, it may be desirable to include a solar reflective, in particular, a double-layered silver coating, on a PET substrate included within an interlayer structure in a laminated glazing. FIG. 7 is a schematic cross section view of a further laminated glazing in accordance with the present invention, and shows a glazing 24 comprising a seven-layer interlayer structure 25 laminated between two plies of glass 26a, 26b. Preferably, the upper ply of glass 26a is clear, although the lower ply of glass 26b may be clear or tinted. The interlayer structure 25 comprises a first interlayer 27, a second interlayer 28, having an LCD film 29 incorporated therein, a third interlayer 30, a first PET substrate 31, a fourth interlayer 32, a second PET substrate 33, having a double silver layer solar control coating, and a fifth interlayer 34. Preferably, the fourth interlayer 32 is a tinted PVB interlayer, and the fifth interlayer 34 a clear PVB or other suitable interlayer material. By using a coated PET substrate to provide solar control and a tinted PVB interlayer, it is possible to produce a colour control glazing without needing to use heavily tinted glasses.

Particularly preferred glazing constructions utilise EVA interlayers only. These interlayers may be combined with a coating on either ply of glass, or with a coated PET substrate to provide appropriate solar control.

Preferably, when a tinted interlayer material is used, it is colour matched to a tinted glass, such as GALAXSEE™ or SUNDYM™, available from Pilkington Group Limited, or blue, grey or green glass.

Suitable functional coatings for use with such a glazing construction when used as a rooflight include low-emissivity coatings, conductive coatings and solar control coatings. A low emissivity coating is a coating which when applied to clear, 3 mm thick float glass, results in the coated glass having an emissivity in the range of 0.05 to 0.45, the actual value being measured in accordance with EN 12898 (a published standard of the European Association of Flat Glass Manufacturers). Hard coatings generally have emissivities between 0.15 and 0.2, whereas off-line coatings generally have emissivities of 0.05 to 0.1. As a comparison, uncoated 3 mm thick float glass has an emissivity of 0.89.

A hard (or pyrolytic) low emissivity coating may comprise a single layer of a metal oxide, preferably a transparent, electrically conductive oxide. Oxides of metals such as tin, zinc, indium, tungsten and molybdenum may be present in the metal oxide layer. Typically, the coating comprises a further dopant, such as fluorine, chlorine, antimony, tin, aluminium, tantalum, niobium, indium or gallium, for example, fluorine-doped tin oxide or tin-doped indium oxide may be used. Such coatings are generally provided with an underlayer, such as silicon or silicon oxynitride. The underlayer acts as a barrier to control migration of alkali metal ions from the glass and/or to suppress iridescent reflection colours caused by variations in thickness of the low emissivity layer.

Off-line (typically sputtered) low emissivity coatings typically comprise a multilayer coating stack, normally including at least one metal layer or electrically conductive metal compound layer, and a dielectric layer. Silver, gold, copper, nickel or chromium may be used as the metal layer, whereas indium oxide, antimony oxide or the like may be used as the electrically conductive compound. Typical multilayer stacks comprise one or two layers of silver deposited between layers of a dielectric such as an oxide of silicon, aluminium, titanium, vanadium, tin, or zinc. Individual layers of such coatings are typically tens of nanometres in thickness. Low emissivity coatings may be provided on either surface of the upper and lower plies of glass in the laminated glazing structure, depending on the combination of interlayers used and desired thermal performance.

Typical solar control coatings comprise layers of silver or tin oxide, and control the amount of heat absorbed through the coated glass. Solar control and low emissivity coatings may also be electrically conductive, and so not only provide functionality to the glass in terms of emissivity and heat transmission, but can form an electrically conductive substrate for mounting electrically conductive devices such as LEDs, sensors and cameras.

A heat reflective solar control coating, for example, a two-layer silver coating, may also be used. Typically, the solar heat reflected by such coatings is greater than 23%, measured in accordance with ISO9050:E(2003), air mass 1.5. Metallic heat reflective coatings may also be electrically conductive, and are particularly useful if the outer ply of glass is of clear glass. Such coatings are typically provided on the inner side of an outer ply of clear glass.

Alternatively, the LCD film may be included within a double-glazed structure. FIG. 8 is a schematic side view of a double-glazed structure 35 including an LCD. The double-glazed structure 35 comprises any of the laminated glazing structures described above, generally represented by reference number 36 in FIG. 8, in combination with an additional upper ply of glass 37, and separated from the glazing structure by an air gap 38. The additional upper ply of glass 37 is toughened and preferably tinted, for example, a dark tint such as that sold as GALAXSEE™, available from Pilkington Group Limited.

The advantage of using a structure including a heat reflective coating (either on a ply of glass or on a separate interlayer) or a double glazed structure including an air gap is that the amount of heat absorbed by the LCD film can be reduced. As the migration of plasticizer and other interlayer material components is a diffusion process, any extra heat absorbed by the LCD film will increase the size of the clear border region. This is a particular problem for glazings that will be used as rooflights in vehicles, where the LCD film may become damaged in-situ.

The present invention therefore provides a glazing which is switchable to alter the amount of light entering a vehicle through the glazing. In addition, images may be projected onto the glazing when the LCD is in an opaque state.

Further embodiments of the invention, within the scope of the appended claims, will be apparent to those skilled in the art.

1. A laminated glazing comprising first and second plies of glass having an interlayer structure laminated therebetween, the interlayer structure comprising a first sheet of an interlayer material framing a liquid crystal film incorporated therein, wherein the components of the interlayer material do not comprise a plasticizer or comprise a plasticizer that does not migrate into the liquid crystal film.

2. The laminated glazing of claim 1, wherein the interlayer material also resists the migration of mobile liquid crystal film components into the interlayer material.

3. A laminated glazing comprising first and second plies of glass having an interlayer structure laminated therebetween, the interlayer structure comprising a first sheet of an interlayer material framing a liquid crystal film incorporated therein, wherein the interlayer material resists the migration of mobile liquid crystal film components into the interlayer material.

4. The laminated glazing of claim 3, wherein the interlayer material components do not comprise a plasticizer or comprise a plasticizer that does not migrate into the liquid crystal film.

5. The laminated glazing of claim 1, wherein the first sheet of interlayer material is laminated between a second and a third sheet of an interlayer material, each in contact with and co-extensive with one of the first and second plies of glass, the liquid crystal film being in contact with at least one sheet of interlayer material.

6. The laminated glazing of claim 5, wherein at least one of the first, second and third sheets of interlayer material is one of ethylene vinyl acetate copolymer, polyurethane, polycarbonate, poly vinyl chloride or a copolymer of ethylene and methacrylic acid.

7. The laminated glazing of claim 5, further comprising a fourth sheet of interlayer material and a barrier layer, the barrier layer being between the first and third sheets of interlayer material, or the third and fourth sheets of interlayer material.

8. The laminated glazing of claim 7, wherein the barrier layer is poly ethylene terephthalate.

9. The laminated glazing of claim 7, wherein the fourth sheet of interlayer material is poly vinyl butyral.

10. The laminated glazing of claim 7, wherein the fourth sheet of interlayer material is coloured and/or has acoustic properties.

11. The laminated glazing of claim 1, wherein the liquid crystal film comprises a coloured substrate.

12. The laminated glazing of claim 7, further comprising a poly ethylene terephthalate substrate having a heat reflective solar control coating and a fifth sheet of an interlayer material, interposed between the fourth sheet of interlayer material and the second ply of glass.

13. The laminated glazing of claim 5 wherein at least one sheet of interlayer material has solar control properties.

14. The laminated glazing of claim 1, further comprising at least one of a solar control, heat reflective, low-emissivity, hydrophobic or hydrophilic coating.

15. The laminated glazing of claim 1, further comprising a third ply of glass, separated from the second ply of glass by an air gap.

16. The laminated glazing of claim 5, wherein the thickness of the first sheet of interlayer material is of the same order as the thickness of the liquid crystal film.

17. (canceled)

18. The laminated glazing of claim 3, wherein the first sheet of interlayer material is laminated between a second and a third sheet of an interlayer material, each in contact with and co-extensive with one of the first and second plies of glass, the liquid crystal film being in contact with at least one sheet of interlayer material.

19. The laminated glazing of claim 18, further comprising a fourth sheet of interlayer material and a barrier layer, the barrier layer being between the first and third sheets of interlayer material, or the third and fourth sheets of interlayer material.

20. The laminated glazing of claim 19, further comprising a poly ethylene terephthalate substrate having a heat reflective solar control coating and a fifth sheet of an interlayer material, interposed between the fourth sheet of interlayer material and the second ply of glass.

21. The laminated glazing of claim 3, wherein the liquid crystal film comprises a coloured substrate.
